(19) United States
(12) Patent Application Publication
(10) Pub. No.: US 2005/0212337 A1
(43) Pub. Date: Sep. 29, 2005

(54) Bicycle saddle with a molded cushioning pad assembly

(76) Inventor: Daniel Lee, Nantou City (TW)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 11/083,659

(22) Filed: Mar. 17, 2005

(30) Foreign Application Priority Data
Mar. 29, 2004 (TW) 093204766

(51) Int. Cl. B62J 1/18

(52) U.S. Cl. 297/214

(57) ABSTRACT

A bicycle saddle includes a seat body having a front nose portion and two rear cantle portions, and a molded cushioning pad assembly having a soft elastomeric body and a deformable pouch embedded in the elastomeric body. The elastomeric body is molded into a shape that compliantly conforms to a contour of an upper wall of the seat body. The deformable pouch includes a fluid-impervious cantle pouch body which has upper and lower major walls defining a compressible chamber therebetween for containing a working fluid in such an amount that upon downward depression of the chamber to squeeze the working fluid radially, the upper major wall is prevented from engaging the lower major wall, thereby providing a cushioning effect. The cantle pouch body is disposed a tone of the cantle portions when the cushioning pad assembly is fitted over the upper wall of the seat body for supporting the rider's buttocks.

### BACKGROUND OF THE INVENTION

1. Field of the Invention

This invention relates to a bicycle saddle, more particularly to a bicycle saddle with a molded cushioning pad assembly fitted over an upper wall of a seat body for enhanced comfort.

2. Description of the Related Art

A conventional bicycle saddle generally includes an elastomeric body mounted on a seat body for providing a cushioning effect. However, the conventional bicycle saddle does not provide support for the rider in radial directions, thereby resulting in lateral deformation and swaying of the elastomeric body laterally after a period of use, which in turn results in flattening of the elastomeric body so as to affect adversely the shock-absorbing effect.

### SUMMARY OF THE INVENTION

The object of the present invention is to provide a bicycle saddle with a molded cushioning pad assembly fitted over an upper wall of a seat body for providing an enhanced feeling of comfort.

According to this invention, the bicycle saddle includes a seat body having a front nose portion and first and second rear cantle portions, and a molded cushioning pad assembly having an elastomeric body and a deformable pouch. The elastomeric body is made from a material that is less rigid than that of the seat body, and is molded into a shape that compliantly conforms to a contour of an upper wall of the seat body. The deformable pouch includes a fluid-impervious cantle pouch body which has upper and lower major walls defining a compressible chamber therebetween and which is made from a flexible material, and a working fluid contained in the compressible chamber in such an amount that upon downward depression of the compressible chamber to squeeze the working fluid radially, the upper major wall is prevented from engaging the lower major wall by the squeezed fluid interposed therebetween, thereby providing a cushioning effect. The cantle pouch body is embedded in the elastomeric body and is disposed at one of the first and second rear cantle portions when the cushioning pad assembly is fitted over the upper wall of the seat body.

### BRIEF DESCRIPTION OF THE DRAWINGS

Other features and advantages of the present invention will become apparent in the following detailed description of the preferred embodiments of the invention, with reference to the accompanying drawings, in which:

FIG. 1 is an exploded perspective view of a preferred embodiment of a bicycle saddle according to this invention;

FIG. 2 is a cross-sectional view of the preferred embodiment in use;

FIG. 3 is a top view showing the position of a deformable pouch relative to a seat body of the preferred embodiment; and

FIG. 4 is an exploded perspective view of another preferred embodiment of the bicycle saddle according to this invention.

### DETAILED DESCRIPTION OF THE PREFERRED EMBODIMENTS

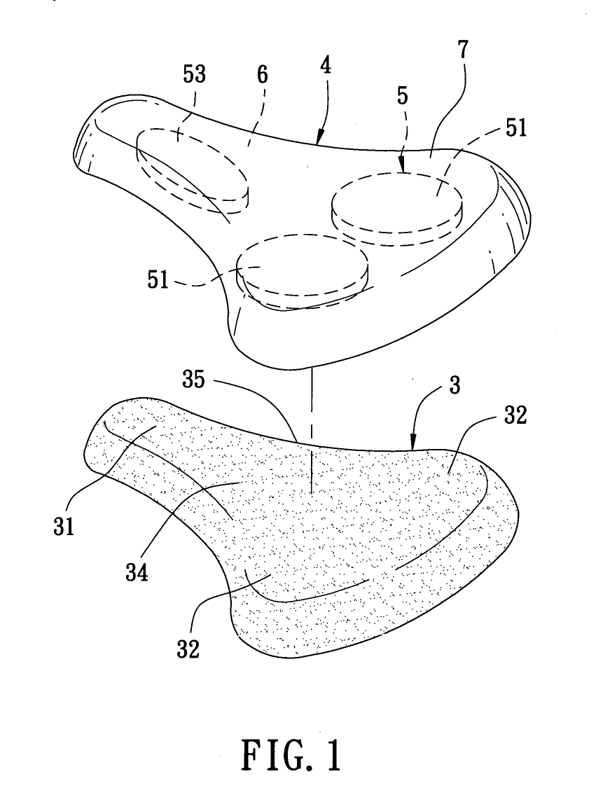

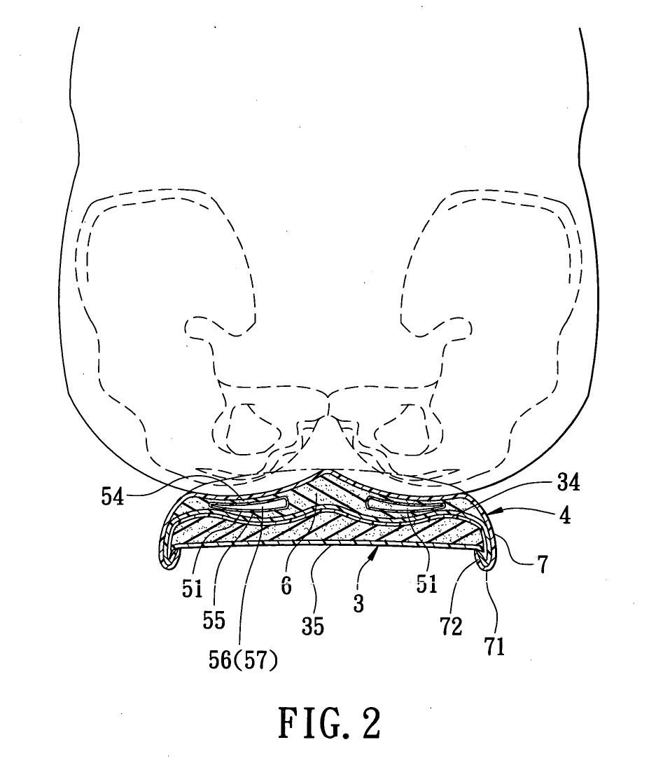

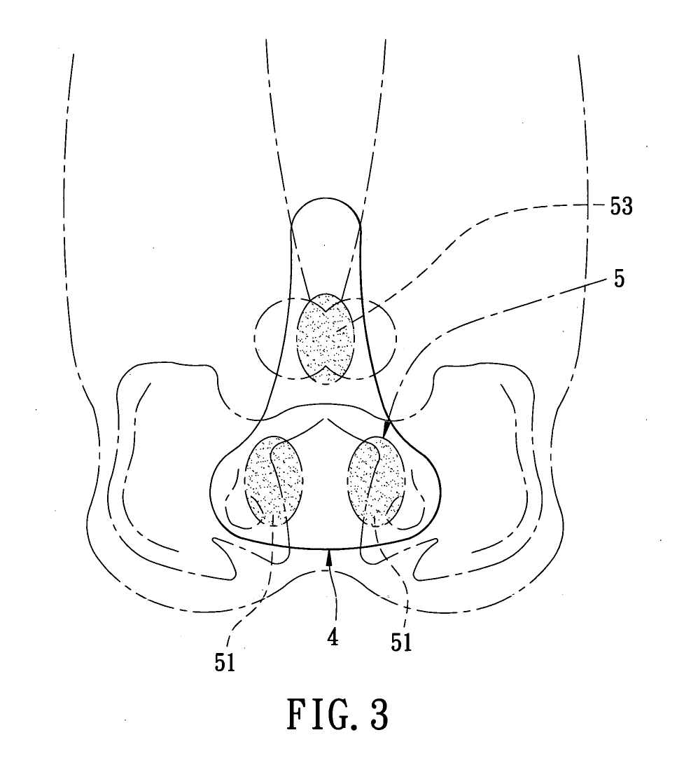

Referring to FIGS. 1 to 3, the preferred embodiment of a bicycle saddle according to the present invention is shown to comprise a seat body 3 and a molded cushioning pad assembly 4.

The seat body 3 has a lower wall 35 which is adapted to be connected to a seat post of a bicycle (not shown), and an upper wall 34 opposite to the lower wall 35 in an upright direction. The upper wall 34 includes a front nose portion 31, and first and second rear cantle portions 32 which are opposite to the front nose portion 31 in a longitudinal direction and which are opposite to each other in a transverse direction. The first and second rear cantle portions 32 are adapted for supporting the fleshier portions of a rider's buttocks.

The molded cushioning pad assembly 4 includes an elastomeric body 6 and a deformable pouch 5. The elastomeric body 6 is made from a material, such as a polyurethane foam material, that is less rigid than that of the seat body 3, and is molded into a shape that compliantly conforms to the contour of the upper wall 34 of the seat body 3. The deformable pouch 5 includes fluid-impervious first and second cantle pouch bodies 51 and a fluid-impervious nose pouch body 53 which are embedded in the elastomeric body 6 and which are disposed at the first and second rear cantle portions 32 and the front nose portion 31 of the upper wall 34 of the seat body 3, respectively, when the cushioning pad assembly 4 is fitted over the upper wall 34 of the seat body 3. Each of the first and second cantle and the nose pouch bodies 51, 53 has upper and lower major walls 54, 55 opposite to each other in the upright direction to define a compressible chamber 56 therebetween, and is made from a flexible material, such as a thermoplastic urethane material. A working fluid 57, such as air, is contained in the compressible chamber 56 in such an amount that upon downward depression of the compressible chamber 56 to squeeze the working fluid 57 radially, the upper major wall 54 is prevented from engaging the lower major wall 55 by the squeezed fluid 57 interposed therebetween, thereby providing a desirable cushioning and supporting effect. A flexible cover 7 is disposed to enclose the cushioning pad assembly 4, and has a peripheral edge 71 extending downwardly beneath the lower wall 35 of the seat body 3 when the cushioning pad assembly 4 is fitted over the upper wall 34 of the seat body 3, and a fastening member 72 which is mounted on the peripheral edge 71 to fasten the peripheral edge 71 onto the lower wall 35.

In this invention, while the elastomeric body 6 provides a relatively soft cushioning effect, the cantle pouch bodies 51 and the nose pouch body 53 provide a relatively rigid support for the parts of the rider's body that are in direct contact with the bicycle saddle, thereby achieving a better shock absorbing effect and thereby affording an enhanced feeling of comfort.

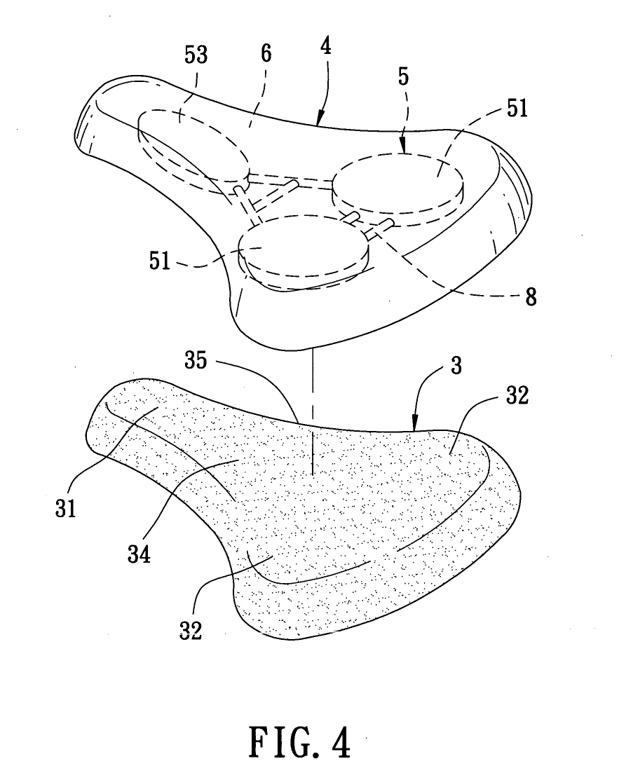

Referring to FIG. 4, another preferred embodiment of a bicycle saddle according to this invention is shown to be similar to the above described embodiment in construction. In this embodiment, the cushioning pad assembly 4 further includes a plurality of connecting ribs 8 which are embedded in the elastomeric body 6 to interconnect the nose and cantle pouch bodies 53, 51 so as to stabilize deformation of the pouch bodies 53, 51 when they are depressed.

While the present invention has been described in connection with what is considered the most practical and preferred embodiments, it is understood that this invention is not limited to the disclosed embodiments but is intended to cover various arrangements included within the spirit and scope of the broadest interpretations and equivalent arrangements.

1. A bicycle saddle comprising:
a seat body having a lower wall adapted to be connected to a seat post of a bicycle, and an upper wall opposite to said lower wall in an upright direction, said upper wall including a front nose portion, and first and second rear cantle portions which are opposite to said front nose portion in a longitudinal direction and which are opposite to each other in a transverse direction, said first and second rear cantle portions being adapted for supporting the fleshier portions of a rider's buttocks; and
a molded cushioning pad assembly including
an elastomeric body made from a material that is less rigid than that of said seat body, and molded into a shape that compliantly conforms to a contour of said upper wall of said seat body, and
a deformable pouch including a fluid-impervious cantle pouch body which has upper and lower major walls opposite to each other in the upright direction to define a compressible chamber therebetween and which is made from a flexible material, and a working fluid contained in said compressible chamber in such an amount that upon downward depression of said compressible chamber to squeeze said working fluid radially, said upper major wall is prevented from engaging said lower major wall by the squeezed fluid interposed therebetween, thereby providing a cushioning effect, said cantle pouch body being embedded in said elastomeric body and being disposed at one of said first and second rear cantle portions when said cushioning pad assembly is fitted over said upper wall of said seat body.

2. The bicycle saddle of claim 1, further comprising a flexible cover which is disposed to enclose said cushioning pad assembly and which has a peripheral edge extending downwardly beneath said lower wall of said seat body when said cushioning pad assembly is fitted over said upper wall of said seat body, and a fastening member which is mounted on said peripheral edge to fasten said peripheral edge onto said lower wall.

3. The bicycle saddle of claim 1, wherein said elastomeric body is made from a polyurethane foam material, and said cantle pouch body is made from a thermoplastic urethane material.

4. The bicycle saddle of claim 1, wherein said deformable pouch further includes a fluid-impervious nose pouch body which is made from the same material as that of said cantle pouch body, which is embedded in said elastomeric body, and which is disposed at said front nose portion when said cushioning pad assembly is fitted over said upper wall of said seat body.

5. The bicycle saddle of claim 4, wherein said cushioning pad assembly further includes a connecting rib embedded in said elastomeric body to interconnect said nose and cantle pouch bodies so as to stabilize the deformation of said nose and cantle pouch bodies when depressed.

6. A molded cushioning pad assembly for a bicycle seat, the bicycle seat including a seat body having a lower wall connected to a seat post, and an upper wall opposite to the lower wall in an upright direction, the upper wall including a front nose portion, and first and second rear cantle portions which are opposite to the front nose portion in a longitudinal direction and which are opposite to each other in a transverse direction, the first and second rear cantle portions being adapted for supporting the fleshier portions of a rider's buttocks, said molded cushioning pad assembly comprising:
an elastomeric body made from a material less rigid than that of the seat body, and molded into a shape that compliantly conforms to a contour of the upper wall of the seat body, and
a deformable pouch including a fluid-impervious cantle pouch body which has upper and lower major walls opposite to each other in the upright direction to define a compressible chamber therebetween and which is made from a flexible material, and a working fluid contained in said compressible chamber in such an amount that upon downward depression of said compressible chamber to squeeze said working fluid radially, said upper major wall is prevented from engaging said lower major wall by the squeezed fluid interposed therebetween, thereby providing a cushioning effect, said cantle pouch body being embedded is said elastomeric body and being adapted to be disposed at one of the first and second rear cantle portions when said cushioning pad assembly is fitted over the upper wall of the seat body.
